(19) United States
(12) Patent Application Publication
(10) Pub. No.: US 2004/0234791 A1
(43) Pub. Date: Nov. 25, 2004

(54) Polypropylene-graft-acrylic acid or polypropylene-graft-maleic anhydride in oxygen scavenging tie layers

(76) Inventors: Ta Yen Ching, Houston, TX (US); James A. Solis, Groves, TX (US); Hu Yang, San Ramon, CA (US); William A. Diecks, Houston, TX (US)

Correspondence Address: Raymund F. Eich, Ph.D., Williams, Morgan & Amerson, P.C., Suite 1100, 10333 Richmond, Houston, TX, 77042, US

(21) Appl. No.: 10/440,657

(22) Filed: May 19, 2003

(51) Int. Cl. B32B 15/08

(52) U.S. Cl. 428/461; 428/515

(57) ABSTRACT

Multilayer packaging articles contain (i) an oxygen scavenging tie layer which includes polypropylene-graft-acrylic acid (PP-g-AA), polypropylene-graft-maleic anhydride (PP-g-MA), or a mixture thereof; (ii) a second layer; and (iii) a third layer, wherein the oxygen scavenging-tie layer is located between the second layer and the third layer. In addition to the oxygen scavenging function, the oxygen scavenging tie layer functions as a tie layer to inhibit delamination of the second layer from the third layer, or vice versa.

### BACKGROUND OF THE INVENTION

1. Field of the Invention

The present invention relates generally to the field of oxygen scavenging polymers. More particularly, it concerns multilayered packaging articles comprising an oxygen scavenging tie layer, a second layer, and a third layer, wherein the oxygen scavenging tie layer comprises polypropylene-graft-acrylic acid (PP-g-AA), polypropylene-graft-maleic anhydride (PP-g-MA), or a mixture thereof.

2. Description of Related Art

It is well known that limiting the exposure of oxygen-sensitive products to oxygen maintains and enhances the quality and shelf-life of the product. For instance, by limiting the oxygen exposure of oxygen sensitive food products in a packaging system, the quality of the food product is maintained, and food spoilage is avoided. In addition such packaging also keeps the product in inventory longer, thereby reducing costs incurred from waste and restocking. In the food packaging industry, several means for limiting oxygen exposure have already been developed, including sealed containers such as cans, bottles, and containers prepared from barrier polymer films; modified atmosphere packaging (MAP); and vacuum packaging.

Another approach involves insertion of oxygen scavenging articles such as an “Ageless” sachet (by Mitsubishi) into food packages to remove residual oxygen, trapped oxygen, dissolved oxygen, ingress oxygen, or oxygen from one or more of these or other sources.

Another technique for limiting oxygen exposure involves incorporating an oxygen scavenger layer into multilayer packaging structures. This approach offers several processing, safety, and cost advantages. First, incorporating an oxygen scavenging layer into a package as part of a continuous package-forming process reduces down time and is simpler than inserting sachets into individual packages. Second, there is no sachet loose in the package to cause accidental ingestion. Third, the process and material costs are significantly cheaper, particularly in high speed packaging fill lines. Incorporation of a scavenger in the package can quickly scavenge residual oxygen, trapped oxygen, dissolved oxygen, or mixtures thereof present inside the package or the food after sealing. Incorporation of a scavenger in the package also scavenges environmental oxygen as it diffuses into the packaging structure.

Generally, the oxygen scavenger functions by irreversibly reacting with oxygen, and as a result, there exists a maximum capacity of oxygen that the scavenger can scavenge which controls the shelf life, efficiency, and cost. Therefore, in certain embodiments it may be beneficial to extend the shelf life, efficiency, and cost of the package by reducing oxygen entry into the package having an oxygen scavenger incorporated therein. One approach involves the inclusion of an oxygen barrier layer in the package.

Ethylene/vinyl alcohol copolymer (EVOH) is widely known for having excellent barrier properties to gases (such as O₂ and CO₂). However, EVOH is a polar polymer, and thus it has poor adhesion to most non-polar packaging structures such as PP or polyethylene (PE). It is known in the art to use a tie layer, such as a tie layer comprising PP- or PE-grafted maleic anhydride (available under the tradename Bynel, DuPont, Wilmington, Del., or under the tradename Orevac, Atofina Chemicals, Philadelphia, Pa.), to provide interlayer adhesion. In addition to EVOH, a variety of layers mismatched in polarity with adjacent layers frequently delaminate from adjacent layers, and the use of a tie layer or layers is thus applicable to a wide range of packaging articles.

Therefore, it would be desirable to have a packaging article comprising an EVOH layer or other gas barrier layer and an oxygen scavenging layer or layers, which packaging article would be better suited for providing a very strong oxygen barrier over a long period of time under adverse conditions such as in presence of moisture, than are packaging articles currently known. Thus, a need exists for an improved way to incorporate oxygen scavenging capability into packages which contain an EVOH layer or other gas barrier layer.

### SUMMARY OF THE INVENTION

In one set of embodiments, the present invention relates to a packaging article, comprising: (i) an oxygen scavenging tie layer comprising either polypropylene-graft-acrylic acid (PP-g-AA), polypropylene-graft-maleic anhydride (PP-g-MA), or a mixture thereof, (ii) a second layer, and (iii) a third layer. The oxygen scavenging tie layer is located adjacent to each of and disposed between the second layer and the third layer. The oxygen scavenging tie layer or a layer adjacent to the oxygen scavenging tie layer comprises a transition metal compound.

The packaging article can be flexible or rigid. The packaging article can further comprise an additional layer or layers.

In another embodiment, the present invention relates to a method of forming a packaging article, comprising forming a first composition comprising either polypropylene-graft-acrylic acid (PP-g-AA), polypropylene-graft-maleic anhydride (PP-g-MA), or a mixture thereof into an oxygen scavenging tie layer of the packaging article, a second composition into a second layer of the packaging article, and a third composition into a third layer of the packaging article. The second layer and the third layer are adjacent to the oxygen scavenging tie layer. The oxygen scavenging tie layer is disposed between the second layer and the third layer. At least one composition selected from the group consisting of the first composition, the second composition, and the third composition comprises a transition metal compound.

The present invention provides packaging articles that have an oxygen scavenging layer which also functions as a tie layer, thereby reducing the materials expense and the processing steps required to form a packaging article with conventional tie layers and conventional oxygen scavenging layers known in the art. The oxygen scavenging tie layer can function as a tie layer between layers other than EVOH layers or as a tie layer with an EVOH layer or layers.

### DESCRIPTION OF ILLUSTRATIVE EMBODIMENTS

In one set of embodiments, the present invention relates to a packaging article. As stated above, the packaging article comprises (i) an oxygen scavenging tie layer comprising either PP-g-AA, PP-g-MA, or a mixture thereof, (ii) a second layer, and (iii) a third layer. The oxygen scavenging tie layer is located adjacent to each of and disposed between the second layer and the third layer. The oxygen scavenging tie layer or a layer adjacent to the oxygen scavenging tie layer comprises a transition metal compound.

Packaging articles typically come in several forms, e.g. flexible or rigid. Typical articles include plastic, paper or cardboard cartons or bottles such as juice containers, soft drink containers, thermoformed trays, or cups, which have wall thicknesses in the range of 100 to 1000 micrometers. Typical flexible bags include those used to package many food items, and will likely have thicknesses of 5 to 250 micrometers. The walls of such articles according to the present invention comprise multiple layers of material.

Packaging articles with multiple layers are typically prepared using coextrusion, injection molding, injection blow molding, stretch blow molding, coating, or lamination, among other techniques. The packaging articles may be rigid or flexible, based on the number and type of layers, the method of formation of the packaging article, and other parameters apparent to one of ordinary skill in the art.

As used herein to refer to layers of a packaging article, “adjacent” means substantially all of a face of a first layer is in direct contact with substantially all of a face of a second layer.

The packaging article can be used to package any product for which it is desirable to inhibit oxygen damage during storage, e.g. food, beverage, pharmaceuticals, medical products, corrodible metals, or electronic devices. In certain embodiments, wherein EVOH is a primary component of at least one of the second layer or the third layer, the packaging article is especially useful for packaging products for which it is desirable to inhibit oxygen damage for a long period of time, e.g. beer, wine, and other beverages. In such embodiments, the packaging article is also especially useful for packaging products for which it is desirable to retain carbon dioxide, e.g. beer, sparkling wine, and soft drinks.

In one embodiment, the oxygen scavenging tie layer comprises polypropylene-graft-acrylic acid (PP-g-AA). PP-g-AA is commercially available as Polybond 1000 (BP Amoco, Naperville, Ill.). PP-g-AA comprises a polypropylene backbone, which contains tertiary hydrogens which are highly oxidizable. In this polymer, some quantity of the polypropylene units are grafted with blocks of one or more acrylic acid units. By “grafted” in this context is meant that an acrylic acid block forms a bond with a carbon atom of a polypropylene unit. One acrylic acid block can be grafted to one, two, or more polypropylene units in one or more polypropylene macromolecules. In one embodiment, less than about 5 mol % of the polypropylene units of the polymer are grafted with an acrylic acid block.

In one embodiment, the oxygen scavenging tie layer comprises polypropylene-graft-maleic anhydride (PP-g-MA). PP-g-MA is commercially available as Admer®, Mitsui Chemicals America, Purchase N.Y.; Tymor, Rohm & Haas, Philadelphia Pa.; or Bynel 5000, DuPont, Wilmington Del. PP-g-MA comprises a polypropylene backbone, which contains tertiary hydrogens which are highly oxidizable. In this polymer, some quantity of the polypropylene units are grafted with blocks of one or more maleic anhydride units. By “grafted” in this context is meant that a maleic anhydride block forms a bond with a carbon atom of a polypropylene unit. One maleic anhydride block can be grafted to one, two, or more polypropylene units in one or more polypropylene macromolecules. In one embodiment, less than about 5 mol % of the polypropylene units of the polymer are grafted with a maleic anhydride block.

The packaging article comprises the oxygen scavenging tie layer, a second layer, and a third layer. The oxygen scavenging tie layer is located adjacent to each of and disposed between the second layer and the third layer. Applicants have discovered the oxygen scavenging tie layer is capable of functioning as both a tie layer for the second layer and the third layer and as an oxygen scavenging layer. By “functioning as a tie layer” is meant that the oxygen scavenging tie layer disposed between the second layer and the third layer inhibits delamination of the second layer from the oxygen scavenging tie layer and the third layer, or delamination of the third layer from the oxygen scavenging tie layer and the second layer, to a greater extent than is seen for the second layer and the third layer in the absence of the oxygen scavenging tie layer. By “inhibits delamination” is meant that the extent to which the second layer and the third layer delaminate one from the other under ordinary conditions (e.g., a time frame of weeks to months and a temperature profile typical in plastics processing, among other parameters), as measured by techniques known to one of ordinary skill in the art, is less in the presence of the oxygen scavenging tie layer than in its absence.

A notable feature of the packaging article is a transition metal compound in the oxygen scavenging tie layer, the second layer, or the third layer. Absence of the transition metal compound or excessively low concentrations (comparable to concentrations resulting from contamination of a composition by a transition metal compound or from processing by steps in which traces of a transition metal compound are able to enter the composition) of the transition metal compound will not be conducive to the oxygen scavenging properties of the oxygen scavenging tie layer. In one embodiment, the oxygen scavenging tie layer comprises the transition metal compound.

The transition metal functions to catalyze oxygen scavenging by the oxygen scavenging polymer, increasing the rate of scavenging and reducing the induction period. Though not to be bound by theory, useful transition metals include those which can readily interconvert between at least two oxidation states. See Sheldon, R. A.; Kochi, J. K.; “Metal-Catalyzed Oxidations of Organic Compounds” Academic Press, New York 1981.

In one embodiment, the transition metal is selected from the first, second or third transition series of the Periodic Table. Suitable metals include, but are not limited to, manganese, iron, cobalt, nickel, copper, rhodium, and ruthenium. The oxidation state of the metal when introduced need not necessarily be that of the active form. The metal is in one embodiment iron, nickel, manganese, cobalt or copper; more in one embodiment manganese or cobalt; and most in one embodiment cobalt. In one embodiment, the transition metal compound is a salt, and more in one embodiment, counterions for the metal include chloride, acetate, oleate, stearate, palmitate, 2-ethylhexanoate, neodecanoate, or naphthenate, in one embodiment C₁-C₂₀ alkanoates. In one embodiment, the salt, the transition metal, and the counterion are either on the U.S. Food and Drug Administration GRAS (generally regarded as safe) list, or exhibit substantially no migration from the packaging article to the product (i.e. less than about 500 ppb, in one embodiment less than about 50 ppb, in the product). Particularly preferable salts include cobalt oleate, cobalt stearate, cobalt 2-ethylhexanoate, and cobalt neodecanoate. The metal salt may also be an ionomer, in which case a polymeric counterion is employed. Such ionomers are well known in the art.

Typically, the amount of transition metal may range from 0.001 to 1 wt % (10 to 10,000 ppm) of the oxygen scavenging tie layer, based on the metal content only (excluding ligands, counterions, etc.).

Another compound that is often in one embodiment added to the oxygen scavenging tie layer is a photoinitiator, or a blend of different photoinitiators, especially if antioxidants are included to prevent premature oxidation of the oxygen scavenging polymer.

Suitable photoinitiators are well known to those skilled in the art. Specific examples include, but are not limited to, benzophenone, o-methoxybenzophenone, acetophenone, o-methoxy-acetophenone, acenaphthenequinone, methyl ethyl ketone, valerophenone, hexanophenone, α-phenyl-butyrophenone, p-morpholinopropiophenone, dibenzosuberone, 4-morpholinobenzophenone, benzoin, benzoin methyl ether, 4-O-morpholinodeoxybenzoin, p-diacetylbenzene, 4-aminobenzophenone, 4′-methoxyacetophenone, α-tetralone, 9-acetylphenanthrene, 2-acetylphenanthrene, 10-thioxanthenone, 3-acetylphenanthrene, 3-acetylindole, 9-fluorenone, 1-indoanone, 1,3,5-triacetylbenzene, thioxanthen-9-one, xanthene-9-one, 7-H-benz[de]anthracen-7-one, benzoin tetrahydropyranyl ether, 4,4′-bis(dimethylamino)-benzophenone, 1′-acetonaphthone, 2′-acetonaphthone, acetonaphthone and 2,3-butanedione, benz[a]anthracene-7,12-dione, 2,2-dimethoxy-2-phenylacetophenone, α,α-diethoxyacetophenone, and α,α-dibutoxyacetophenone, among others. Singlet oxygen generating photosensitizers such as Rose Bengal, methylene blue, and tetraphenyl porphine may also be employed as photoinitiators. Polymeric initiators include poly(ethylene carbon monoxide) and oligo[2-hydroxy-2-methyl-1-[4-(1-methylvinyl)phenyl]propanone].

Use of a photoinitiator is preferable because it generally provides faster and more efficient initiation of oxygen scavenging by the oxygen scavenging polymer. However, due to the high cost of photoinitiators, it is desirable to use the minimum amount of photoinitiator required to initiate oxygen scavenging. This minimum amount will vary depending on the photoinitiator used, the wavelength and intensity of ultraviolet light used to initiate, and other factors. In one embodiment, the photoinitiator is either on the U.S. Food and Drug Administration GRAS (generally regarded as safe) list, or exhibits substantially no migration from the packaging article to the product (i.e. less than 50 ppb in the product).

Photoinitiators that are especially useful in the present invention include benzophenone derivatives containing at least two benzophenone moieties, as described in U.S. Pat. No. 6,139,770. These compounds act as effective photoinitiators to initiate oxygen scavenging activity in the oxygen barrier composition of the present invention. Such benzophenone derivatives have a very low degree of extraction from oxygen scavenging compositions, which may lead to reduced malodor or off-taste of a packaged food, beverage, or oral pharmaceutical product by extracted photoinitiator.

A “benzophenone moiety” is a substituted or unsubstituted benzophenone group. Suitable substituents include alkyl, aryl, alkoxy, phenoxy, and alicylic groups contain from 1 to 24 carbon atoms or halides.

The benzophenone derivatives include dimers, trimers, tetramers, and oligomers of benzophenones and substituted benzophenones.

The benzophenone photoinitiators are represented by the formula:

Aₐ(B)_{b}

wherein A is a bridging group selected from sulfur; oxygen; carbonyl; —SiR″₂—, wherein each R″ is individually selected from alkyl groups containing from 1 to 12 carbon atoms, aryl groups containing 6 to 12 carbon atoms, or alkoxy groups containing from 1 to 12 carbon atoms; —NR′″-, wherein R′″ is an alkyl group containing 1 to 12 carbon atoms, an aryl group containing 6 to 12 carbon atoms, or hydrogen; or an organic group containing from 1 to 50 carbon atoms; a is an integer from 0 to 11; B is a substituted or unsubstituted benzophenone group; and b is an integer from 2 to 12.

The bridging group A can be a divalent group, or a polyvalent group with 3 or more benzophenone moieties. The organic group, when present, can be linear, branched, cyclic (including fused or separate cyclic groups), or an arylene group (which can be a fused or non-fused polyaryl group). The organic group can contain one or more heteroatoms, such as oxygen, nitrogen, phosphorous, silicon, or sulfur, or combinations thereof. Oxygen can be present in, for example, an ether, ketone, aldehyde, ester, or alcohol.

The substituents of B, herein R″, when present, are individually selected from alkyl, aryl, alkoxy, phenoxy, or alicylic groups containing from 1 to 24 carbon atoms, or halides. Each benzophenone moiety can have from 0 to 9 substituents.

In one embodiment, the combined molecular weight of the A and R″ groups is at least about 30 g/mole. Substituents can be selected to render the photoinitiator more compatible with the oxygen scavenging tie layer.

Examples of such benzophenone derivatives comprising two or more benzophenone moieties include dibenzoyl biphenyl, substituted dibenzoyl biphenyl, benzoylated terphenyl, substituted benzoylated terphenyl, tribenzoyl triphenylbenzene, substituted tribenzoyl triphenylbenzene, benzoylated styrene oligomer (a mixture of compounds containing from 2 to 12 repeating styrenic groups, comprising dibenzoylated 1,1-diphenyl ethane, dibenzoylated 1,3-diphenyl propane, dibenzoylated 1-phenyl naphthalene, dibenzoylated styrene dimer, dibenzoylated styrene trimer, and tribenzoylated styrene trimer), and substituted benzoylated styrene oligomer. In one embodiment, the photoinitiator can be tribenzoyl triphenylbenzene or substituted tribenzoyl triphenylbenzene.

When a photoinitiator is used, its primary function is to enhance and facilitate the initiation of oxygen scavenging by the oxygen scavenging tie layer upon exposure to radiation. The amount of photoinitiator can vary. In many instances, the amount will depend on the blend ratio or the particular oxygen scavenging polymer used, the wavelength and intensity of UV radiation used, the nature and amount of antioxidants used, as well as the type of photoinitiator used, among other parameters. For instance, if the photoinitiator-containing component is placed underneath a layer which is somewhat opaque to the radiation used, more initiator may be needed. For most purposes, however, the amount of photoinitiator, when used, will be in the range of 0.01 to 10% by weight of the oxygen scavenging tie layer.

Other additives can be added to further facilitate or control the initiation of oxygen scavenging properties by the oxygen scavenging tie layer. Also, additional components such as a structural polymer or polymers can be added to render the layer more adaptable for use in a packaging article. Particular additives and components to be included in the oxygen scavenging tie layer can be readily chosen by the skilled artisan, depending on the intended use of the oxygen scavenging tie layer and other parameters.

Antioxidants may be used in the oxygen scavenging tie layer to control scavenging initiation. An antioxidant as defined herein is a material which inhibits oxidative degradation or cross-linking of polymers. Typically, antioxidants are added to facilitate the processing of polymeric materials or prolong their useful lifetime. In relation to this invention, such additives prolong the induction period for oxygen scavenging in the absence of irradiation. When it is desired to commence oxygen scavenging by the oxygen scavenging tie layer of the packaging article, the packaging article (and any incorporated photoinitiator) can be exposed to radiation.

Antioxidants such as 2,6-di(t-butyl)-4-methylphenol(BHT), 2,2′-methylene-bis(6-t-butyl-p-cresol), triphenylphosphite, tris-(nonylphenyl)phosphite, vitamin E, tetra-bismethylene 3-(3,5-ditertbutyl-4-hydroxyphenyl)-propionate methane, and dilaurylthiodipropionate are suitable for use with this invention.

The amount of antioxidant which may be present may also have an effect on oxygen scavenging. Antioxidants are usually present in oxidizable organic compounds or structural polymers to prevent oxidation or gelation of the polymers. Typically, they are present in about 0.01 to 1% by weight of the oxygen scavenging tie layer. However, additional amounts of antioxidant may also be added if it is desired to tailor the induction period, as will be apparent to one of ordinary skill in the art.

Other additives which can be included in the oxygen scavenging tie layer include, but are not necessarily limited to, fillers, pigments, dyestuffs, stabilizers, processing aids, plasticizers, fire retardants, and anti-fog agents, among others. Any other additives employed normally will not comprise more than 10% of the oxygen scavenging tie layer by weight, with preferable amounts being less than 5% of the oxygen scavenging tie layer by weight.

The oxygen scavenging tie layer can also comprise a structural polymer or polymers. Such polymers are thermoplastic and render the oxygen scavenging tie layer more adaptable for use in a packaging article. They also may, to some extent, provide a barrier to oxygen entry into the packaging article. Suitable structural polymers include, but are not limited to, polyethylene (PE), low density polyethylene (LDPE), very low density polyethylene (VLDPE), ultra-low density polyethylene (ULDPE), high density polyethylene (HDPE), polypropylene (PP), polystyrene (PS), polymethacrylate (PMA), polymethylmethacrylate (PMMA), polyethylene terephthalate (PET), polyvinyl chloride, ethylene-vinyl acetate, ethylene-alkyl (meth)acrylates, ethylene-(meth)acrylic acid, or ethylene-(meth)acrylic acid ionomers. In beverage containers, PET is often used.

Blends of different structural polymers may also be used. However, the selection of the structural polymer largely depends on the article to be manufactured and the end use thereof. Such selection factors are well known in the art. For instance, the clarity, cleanliness, effectiveness as an oxygen scavenger, barrier properties, mechanical properties, or texture of the article can be adversely affected by a blend containing a structural polymer which is incompatible with the oxygen scavenging polymer.

In one embodiment, the structural polymer is selected from PET, PP, LDPE, HDPE, PS, PMA, PMMA, or mixtures thereof.

The second layer and the third layer of the packaging article can independently comprise any of a variety of polymers or structural materials.

In one embodiment, the second layer, the third layer, or both comprise ethylene-vinyl alcohol (EVOH), polymers or copolymers of acrylonitrile, polyvinyl chloride (PVC), poly(vinylidene dichloride), polyethylene terephthalate (PET), polyethylene napthalate, nylon 6, nylon 6,6, aromatic polyamide, semiaromatic polyamide, or mixtures thereof. The polymers of this embodiment would generally be expected to increase the oxygen barrier properties of the packaging article.

In one embodiment, both the second layer and the third layer comprise EVOH.

In another embodiment, the second layer, the third layer, or both comprise either a structural polymer selected from polyethylene (PE), low density polyethylene (LDPE), very low density polyethylene, ultra-low density polyethylene, high density polyethylene (HDPE), ungrafted polypropylene (PP), polystyrene (PS), polymethacrylate (PMA), polymethylmethacrylate (PMMA), polyethylene terephthalate (PET), polyvinyl chloride, ethylene-vinyl acetate, ethylene-alkyl (meth)acrylates, ethylene-(meth)acrylic acid, ethylene-(meth)acrylic acid ionomers, or mixtures thereof; or a structural material selected from paperboard or cardboard. By “ungrafted polypropylene” is meant PP not grafted with acrylic acid or maleic anhydride. Polypropylenes with other types of blocks grafted thereonto are within the scope of “ungrafted polypropylene,” as used herein. The polymers or structural materials of this embodiment would generally be expected to increase the strength or one or more other physical properties of the packaging article.

One or more layers of the packaging article may further comprise at least one oxygen barrier layer. By “oxygen barrier layer” is meant a layer having an oxygen transmission rate equal to or less than 100 cubic centimeters per square meter (cc/m²) per day per atmosphere at room temperature (about 25° C.). Such an oxygen barrier layer may comprise EVOH, homopolymers or copolymers of acrylonitrile, polyvinyl chloride, poly(vinylidene dichloride), polyethylene terephthalate (PET), polyethylene napthalate, silica, metal foil, polyamides (e.g. nylon 6, nylon 6,6, aromatic polyamide, or semiaromatic polyamide), or mixtures thereof. However, if the packaging article comprises an EVOH oxygen barrier layer adjacent to the oxygen scavenging tie layer, the package is expected to inhibit oxygen transmission to a high degree, and thus the need for an additional oxygen barrier layer is reduced and may, depending on the form of the packaging article and the intended use, be dispensed with entirely, if desired.

Other additional layers of the packaging article may include one or more layers which are permeable to oxygen.

Further additional layers, such as adhesive layers, may also be used in the packaging article. Compositions typically used for adhesive layers include anhydride functional polyolefins and other well-known adhesive layers. Such adhesive layers may be used as tie layers between no more than one face of each EVOH oxygen barrier layer and other layers of the packaging article.

In another embodiment, the second layer, the third layer, or both comprise an organic compound that irreversibly reacts with oxygen. The organic compound is in one embodiment a polymer which comprises a hydrocarbon group or groups and a polymeric backbone. The hydrocarbon can be saturated or unsaturated, and substituted or unsubstituted. Examples of such hydrocarbons include, but are not limited to, diene polymers such as polyisoprene, polybutadiene, and copolymers thereof, e.g. styrene-butadiene. Such hydrocarbons also include polymeric compounds such as polypentenamer, polyoctenamer, and other polymers prepared by olefin metathesis; diene oligomers such as squalene; and polymers or copolymers derived from dicyclopentadiene, norbornadiene, 5-ethylidene-2-norbornene, or other monomers containing more than one carbon-carbon double bond (conjugated or non-conjugated). These hydrocarbons further include carotenoids such as β-carotene.

Examples of substituted hydrocarbons include, but are not limited to, those with oxygen-containing moieties, such as esters, carboxylic acids, aldehydes, ethers, ketones, or alcohols. Specific examples of such hydrocarbons include, but are not limited to, condensation polymers such as polyesters derived from monomers containing carbon-carbon double bonds; unsaturated fatty acids such as oleic, ricinoleic, dehydrated ricinoleic, and linoleic acids and derivatives thereof, e.g. esters. Such hydrocarbons also include polymers or copolymers derived from allyl (meth)acrylates, or polymers containing nitrogen, such as nylon or MXD6, among others.

In one embodiment, the organic compound is an oxygen scavenging polymer comprising an ethylenic backbone and a cycloalkenyl group with structure I:

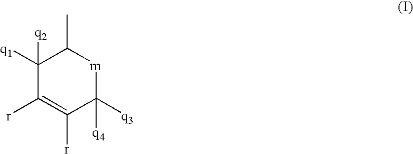

wherein q₁, q₂, q₃, q₄, and r are independently selected from hydrogen, methyl, or ethyl; m is —(CH₂)ₙ—, wherein n is an integer from 0 to 4, inclusive; and, when r is hydrogen, at least one of q₁, q₂, q₃, and q₄ is also hydrogen. Such a polymer will render the layer oxygen scavenging, especially if a various additives such as a transition metal catalyst, a photoinitiator, and an antioxidant, among others, are located in the same or adjacent layer or layers of the packaging article, as described above and apparent to one of ordinary skill in the art.

In one embodiment, the oxygen scavenging compound is ethylene/vinyl cyclohexene copolymer (EVCH).

In one embodiment, the oxygen scavenging polymer further comprises a linking group linking the ethylenic backbone to the cyclic olefinic group. The linking group is selected from:

—O—(CHR)ₙ—; —C(═O)—O—(CHR)ₙ—; —NH—(CHR)ₙ—; —O—C(═O)—(CHR)ₙ—; —C(═O)—NH—(CHR)ₙ—; or —C(═O)—O—CHOH—CH₂—O—.

In one embodiment, the cyclic olefinic group is a cycloalkenyl group having structure I. In one embodiment, in structure I, n is 1, and q₁, q₂, q₃, q₄, and r are each hydrogen. In one embodiment, the oxygen scavenging polymer is a cyclohexenylmethyl acrylate homopolymer (CHAA), a cyclohexenylmethyl acrylate copolymer, a cyclohexenylmethyl methacrylate homopolymer (CHMA), a cyclohexenylmethyl methacrylate copolymer, or mixtures thereof. In one embodiment, the oxygen scavenging polymer is ethylene/methyl acrylate/cyclohexenylmethyl acrylate copolymer (EMCM).

The oxygen scavenging layer can comprise from about 0.1% to about 100% of the oxygen scavenging polymer by weight. In one embodiment, the oxygen scavenging layer comprises from about 30% to about 95% of the oxygen scavenging polymer by weight. The remainder of the oxygen scavenging layer can be made up of other additives, as described below.

The oxygen scavenging layer, or a layer adjacent thereto, optionally can further comprise a transition metal.

It should be noted that PP-g-AA and PP-g-MA may generate fragments upon scavenging oxygen. Therefore, when the packaging article is intended for food storage applications, it is desirable for the packaging article to include in one or more layers between the oxygen scavenging tie layer and the interior of the packaging article a structure sufficient to substantially inhibit migration of any fragments into the interior of the packaging article. The sufficient structure may be provided by a particular thickness of the one or more layers, or a particular composition of the one or more layers, or both. A sufficient structure will be apparent to one of ordinary skill in the art.

In certain embodiments, the packaging article may comprise a layer or layers in addition to the three layers described above, such as an oxygen scavenging layer or layers (other than the oxygen scavenging tie layer); a food-contact layer; a structural layer or layers; a tie layer or layers (other than the oxygen scavenging tie layer); or an adhesive layer or layers; among others, alone or in any combination.

In one packaging article, useful for packaging of food and scavenging of oxygen found in the packaged food, the layers include, in order starting from the outside of the package to the innermost layer of the package, (i) a moisture barrier layer, (ii) an EVOH oxygen barrier layer, (iii) an oxygen scavenging tie layer, and (iv) an oxygen-permeable layer. A tie layer may also be used between layers (i) and (ii) if the moisture barrier layer lacks sufficient adhesion to inhibit delamination of the EVOH oxygen barrier layer from layer (i). Control of the oxygen barrier property of (ii) limits the rate of oxygen entry to the oxygen scavenging moieties in layer (iii), and thus slows the consumption of oxygen scavenging capacity by atmospheric oxygen. Control of the oxygen permeability of layer (iv) allows setting the rate of oxygen scavenging for the overall structure independent of the composition of the scavenging component (iii). Furthermore, layer (iv) can provide a barrier to migration of the components of the outer layers, or by-products of the reaction of such components with oxygen or other reactants, into the package interior. Even further, layer (iv) can improve the heat-sealability, clarity, or resistance to blocking of the packaging article.

In another set of embodiments, the present invention relates to a method of forming a packaging article, the method comprising:

forming a first composition comprising either PP-g-AA, PP-g-MA, or a mixture thereof into an oxygen scavenging tie layer of the packaging article, a second composition into a second layer of the packaging article, and a third composition into a third layer of the packaging article.

The second layer and the third layer are adjacent to the oxygen scavenging tie layer, and the oxygen scavenging tie layer is disposed between the second layer and the third layer. At least one composition selected from the group consisting of the first composition, the second composition, and the third composition comprises a transition metal compound.

The packaging article can be flexible or rigid, as described above. PP-g-AA, PP-g-MA, the transition metal compound, and other components of the oxygen scavenging tie layer, the second layer, and the third layer have been described above.

The forming step can be by any techniques appropriate depending on the compositions, the packaging article, and other parameters. As mentioned above, packaging articles with multiple layers are typically prepared using coextrusion, injection molding, blow molding, injection blow molding, stretch blow molding, coating, or lamination, among other techniques.

The oxygen scavenging composition can also comprise a photoinitiator, an antioxidant, a structural polymer, or other additives as described above.

In addition to the oxygen scavenging tie layer, the second layer, and the third layer, the packaging article to be formed can comprise other layers, as described above. Depending on the desired form of the packaging article, the forming step can comprise forming the packaging article as a flexible article or a rigid article.

The following examples are included to demonstrate particular embodiments of the invention. It should be appreciated by those of skill in the art that the techniques disclosed in the examples which follow represent techniques discovered by the inventor to function well in the practice of the invention. However, those of skill in the art should, in light of the present disclosure, appreciate that many changes can be made in the specific embodiments which are disclosed and still obtain a like or similar result without departing from the spirit and scope of the invention.

### EXAMPLE 1

An extruded monolayer cast film was prepared by blending (i) 10 wt % cobalt masterbatch, containing 10.4 wt % cobalt as cobalt oleate, 1 wt % tribenzoyl triphenylbenzene, and balance ethylene/methyl acrylate copolymer and (ii) 90 wt % polypropylene-graft-maleic anhydride resin (0.2 mol % maleic anhydride, commercially available as Admer® QF551A, Mitsui Chemicals America, Purchase, N.Y.). The film was ˜1.5 mils thick. A test sheet of the film (surface area 200 cm², weight ˜0.7 g) was prepared.

The test sheet was activated with 2 min exposure to UVC light, and introduced into a foil pouch. The foil pouch was filled with 400 cc air (21.4% O₂), sealed, and maintained at room temperature. The oxygen content of the foil pouch was measured by extracting an aliquot of headspace gas via a syringe and quantifying oxygen concentration by use of a Mocon oxygen analyzer. Oxygen concentration (vol %) in the headspace and volume of oxygen scavenged are reported in the following table.

| | Headspace O₂ Conc. | | cc O₂ Scavenged/ |
|---|---|---|---|
| Day | (vol %) | cc O₂ Scavenged | g Film |
| 0.00 | 21.40 | 0.00 | 0.00 |
| 0.88 | 21.15 | 0.63 | 0.91 |
| 1.86 | 21.15 | 0.63 | 0.91 |
| 2.92 | 21.15 | 0.63 | 0.91 |
| 7.91 | 20.95 | 1.10 | 1.57 |
| 14.90 | 21.10 | 0.76 | 1.09 |
| 21.88 | 20.45 | 2.18 | 3.12 |
| 35.88 | 16.80 | 9.55 | 13.64 |
| 49.07 | 14.35 | 13.99 | 19.99 |
| 62.00 | 11.25 | 19.09 | 27.28 |

These results indicate polypropylene-graft-maleic anhydride is capable of scavenging oxygen.

All of the compositions and methods disclosed and claimed herein can be made and executed without undue experimentation in light of the present disclosure. While the compositions and methods of this invention have been described in terms of particular embodiments, it will be apparent to those of skill in the art that variations may be applied to the compositions and methods and in the steps or in the sequence of steps of the method described herein without departing from the concept, spirit and scope of the invention as defined by the appended claims.

What is claimed is:

1. A packaging article, comprising:
an oxygen scavenging tie layer comprising either polypropylene-graft-acrylic acid (PP-g-AA), polypropylene-graft-maleic anhydride (PP-g-MA), or a mixture thereof,
a second layer, and
a third layer,
wherein the oxygen scavenging tie layer is located adjacent to each of and disposed between the second layer and the third layer and the oxygen scavenging tie layer or a layer adjacent to the oxygen scavenging tie layer comprises a transition metal compound.

2. The packaging article of claim 1, wherein the oxygen scavenging tie layer comprises the transition metal compound.

3. The packaging article of claim 1, wherein the transition metal is selected from cobalt, copper, nickel, iron, manganese, rhodium, or ruthenium.

4. The packaging article of claim 3, wherein the transition metal compound comprises a counterion selected from C₁-C₂₀ alkanoates.

5. The packaging article of claim 4, wherein the transition metal compound is cobalt oleate, cobalt stearate, or cobalt neodecanoate.

6. The packaging article of claim 1, further comprising a photoinitiator in the oxygen scavenging tie layer.

7. The packaging article of claim 6, wherein the photoinitiator is selected from dibenzoyl biphenyl, substituted dibenzoyl biphenyl, benzoylated terphenyl, substituted benzoylated terphenyl, tribenzoyl triphenylbenzene, substituted tribenzoyl triphenylbenzene, benzoylated styrene oligomer, or substituted benzoylated styrene oligomer.

8. The packaging article of claim 1, wherein the second layer, the third layer, or both comprise ethylene-vinyl alcohol (EVOH), polymers or copolymers of acrylonitrile, polyvinyl chloride (PVC), poly(vinylidene dichloride), polyethylene terephthalate (PET), polyethylene napthalate, nylon 6, nylon 6,6, aromatic polyamide, semiaromatic polyamide, or mixtures thereof.

9. The packaging article of claim 8, wherein both the second layer and the third layer comprise EVOH.

10. The packaging article of claim 1, wherein the second layer, the third layer, or both comprise either a structural polymer selected from polyethylene (PE), low density polyethylene (LDPE), very low density polyethylene, ultra-low density polyethylene, high density polyethylene (HDPE), ungrafted polypropylene (PP), polystyrene (PS), polymethacrylate (PMA), polymethylmethacrylate (PMMA), polyethylene terephthalate (PET), polyvinyl chloride, ethylene-vinyl acetate, ethylene-alkyl (meth)acrylates, ethylene-(meth)acrylic acid, ethylene-(meth)acrylic acid ionomers, or mixtures thereof, or a structural material selected from paperboard or cardboard.

11. The packaging article of claim 1, wherein the second layer, the third layer, or both comprise an oxygen scavenging polymer comprising an ethylenic backbone and a cycloalkenyl group with structure I: 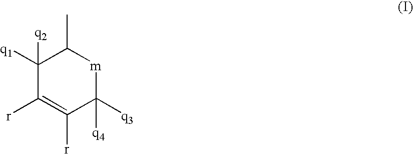
wherein q₁, q₂, q₃, q₄, and r are independently selected from hydrogen, methyl, or ethyl; m is —(CH₂)ₙ—, wherein n is an integer from 0 to 4, inclusive; and, when r is hydrogen, at least one of q₁, q₂, q₃, and q₄ is also hydrogen.

12. The packaging article of claim 11, wherein the oxygen scavenging polymer in the second layer, the third layer, or both further comprises a linking group between the ethylenic backbone and the pendant group, wherein the linking group is selected from:
—O—(CHR)ₙ—; —C(═O)—O—(CHR)ₙ—; —NH—(CHR)ₙ—; —O—C(═O)—(CHR)ₙ—;
—C(═O)—NH—(CHR)ₙ—; or —C(═O)—O—CHOH—CH₂—O—.

13. The packaging article of claim 11, wherein the oxygen scavenging polymer is selected-from EMCM, EVCH, CHAA, CHMA, or mixtures thereof.

14. The packaging article of claim 1, wherein less than about 5 mol % of the polypropylene units of the polymer are grafted with an acrylic acid block.

15. The packaging article of claim 1, wherein less than about 5 mol % of the polypropylene units of the polymer are grafted with a maleic anhydride block.

16. A packaging article, comprising:
a gas barrier layer comprising a polymer selected from the group consisting of ethylene-vinyl alcohol (EVOH), polymers or copolymers of acrylonitrile, polyvinyl chloride (PVC), poly(vinylidene dichloride), polyethylene terephthalate (PET), polyethylene napthalate, nylon 6, nylon 6,6, aromatic polyamide, semiaromatic polyamide, and mixtures thereof;
an oxygen scavenging tie layer comprising either polypropylene-graft-acrylic acid (PP-g-AA), polypropylene-graft-maleic anhydride (PP-g-MA), or a mixture thereof, and a structural layer comprising a component selected from the group consisting of polyethylene (PE), low density polyethylene (LDPE), very low density polyethylene, ultra-low density polyethylene, high density polyethylene (HDPE), ungrafted polypropylene (PP), polystyrene (PS), polymethacrylate (PMA), polymethylmethacrylate (PMMA), polyethylene terephthalate (PET), polyvinyl chloride, ethylene-vinyl acetate, ethylene-alkyl (meth)acrylates, ethylene-(meth)acrylic acid, ethylene-(meth)acrylic acid ionomers, a structural material selected from the group consisting of paperboard and cardboard, and mixtures thereof,
wherein the oxygen scavenging tie layer is located adjacent to each of and disposed between the gas barrier layer and the structural layer, and the oxygen scavenging tie layer or a layer adjacent to the oxygen scavenging tie layer comprises a transition metal compound selected from the group consisting of cobalt oleate, cobalt stearate, cobalt neodecanoate, and mixtures thereof.

17. A method of forming a packaging article, comprising:
forming a first composition comprising either polypropylene-graft-acrylic acid (PP-g-AA), polypropylene-graft-maleic anhydride (PP-g-MA), or a mixture thereof into an oxygen scavenging tie layer of the packaging article, a second composition into a second layer of the packaging article, and a third composition into a third layer of the packaging article, wherein the second layer is adjacent to the oxygen scavenging tie layer, the third layer is adjacent to the oxygen scavenging tie layer, the oxygen scavenging tie layer is disposed between the second layer and the third layer, and wherein at least one composition selected from the group consisting of the first composition, the second composition, and the third composition comprises a transition metal compound.

18. The method of claim 17, wherein the first composition comprises the transition metal compound.

19. The method of claim 17, wherein the first composition further comprises a photoinitiator.

20. The method of claim 17, wherein the second composition, the third composition, or both comprise ethylene-vinyl alcohol (EVOH), polymers or copolymers of acrylonitrile, polyvinyl chloride (PVC), poly(vinylidene dichloride), polyethylene terephthalate (PET), polyethylene napthalate, nylon 6, nylon 6,6, aromatic polyamide, semiaromatic polyamide, or mixtures thereof.

21. The method of claim 17, wherein the second composition, the third composition, or both comprise either a structural polymer selected from polyethylene (PE), low density polyethylene (LDPE), very low density polyethylene, ultra-low density polyethylene, high density polyethylene (HDPE), ungrafted polypropylene (PP), polystyrene (PS), polymethacrylate (PMA), polymethylmethacrylate (PMMA), polyethylene terephthalate (PET), polyvinyl chloride, ethylene-vinyl acetate, ethylene-alkyl (meth)acrylates, ethylene-(meth)acrylic acid, ethylene-(meth)acrylic acid ionomers, or mixtures thereof;
or a structural material selected from paperboard or cardboard.

22. The method of claim 17, wherein the second composition, the third composition, or both comprise an oxygen scavenging polymer comprising an ethylenic backbone and a cycloalkenyl group with structure I: 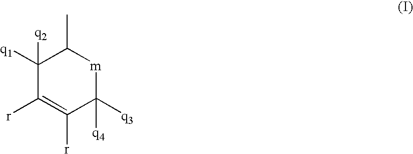
wherein q₁, q₂, q₃, q₄, and r are independently selected from hydrogen, methyl, or ethyl; m is —(CH₂)ₙ—, wherein n is an integer from 0 to 4, inclusive; and, when r is hydrogen, at least one of q₁, q₂, q₃, and q₄ is also hydrogen.
